(19) United States
(12) Patent Application Publication
(10) Pub. No.: US 2025/0149539 A1
(43) Pub. Date: May 8, 2025

(54) HIGH POWER CATHODE ELECTRODES FOR SOLID-STATE BATTERIES

(71) Applicant: GM GLOBAL TECHNOLOGY OPERATIONS LLC, Detroit, MI (US)

(72) Inventors: Qili SU, Shanghai (CN); Zhe LI, Shanghai (CN); Haijing LIU, Shanghai (CN)

(21) Appl. No.: 18/521,119

(22) Filed: Nov. 28, 2023

(30) Foreign Application Priority Data
Nov. 3, 2023 (CN) 202311460024.0

(51) Int. Cl. H01M 4/131; H01M 4/02

(52) U.S. Cl. CPC H01M 4/131; H01M 2004/027; H01M 2300/0065

(57) ABSTRACT

A solid-state battery cell includes A anode electrodes including an anode active material layer arranged on an anode current collector, C cathode electrodes including a cathode active material layer arranged on a cathode current collector. The cathode active material layer includes cathode active material comprising particles including an outer layer of a material selected from a group consisting of LiNbO₃, Li₂ZrO₃, Li₃PO₄, and combinations thereof. A solid electrolyte has a D₅₀ size in a range from 4 μm to 12 μm. S separators are arranged between the A anode electrodes and the C cathode electrodes, where A, C, and S are integers greater than one.

### CROSS-REFERENCE TO RELATED APPLICATIONS

This application claims the benefit of Chinese Patent Application No. 202311460024.0, filed on Nov. 3, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to high power cathode electrodes for solid-state batteries.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A solid-state battery cell includes A anode electrodes including an anode active material layer arranged on an anode current collector, C cathode electrodes including a cathode active material layer arranged on a cathode current collector. The cathode active material layer includes cathode active material comprising particles including an outer layer of a material selected from a group consisting of LiNbO₃, Li₂ZrO₃, Li₃PO₄, and combinations thereof. A solid electrolyte has a D₅₀ size in a range from 4 μm to 12 μm. S separators are arranged between the A anode electrodes and the C cathode electrodes, where A, C, and S are integers greater than one.

In other features, the particles comprise lithium-nickel-cobalt-manganese (NMC) particles and the outer layer comprises LiNbO₃. The NMC particles have diameter of 2 μm<D₅₀<5 μm. Nickel comprises 50 to 72 mol % of the NMC particles, manganese comprises 8 to 40 mol % of the NMC particles, and cobalt comprises 10 to 20 mol % of the NMC particles. The outer layer has a thickness in a range from 7 nm to 13 nm. The solid electrolyte in the cathode active material layer has a diameter D₉₀<15 μm. The solid electrolyte comprises a sulfide solid electrolyte selected from a group consisting of pseudobinary sulfide, pseudoternary sulfide, and pseudoquaternary sulfide.

In other features, the solid electrolyte is selected from a group consisting of halide-based solid electrolyte and hydride-based solid electrolyte. The cathode active material is selected from a group consisting of rock salt layered oxides, spinel, polyanion cathode, olivine cathode, other lithium transition-metal oxides, surface-coated and/or doped cathode materials, and combinations thereof. The cathode active material layer further comprises conductive additive selected from a group consisting of carbon black, graphite, graphene, graphene oxide, Super P, acetylene black, carbon nanofibers, carbon nanotubes, and combinations thereof. The cathode active material layer further comprises a binder selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), styrene butadiene styrene copolymer (SBS), and combinations thereof.

A dry method for manufacturing a cathode electrode for a solid-state battery cell includes mixing cathode active material comprising particles having an outer layer selected from a group consisting of LiNbO₃, Li₂ZrO₃, Li₃PO₄, and combinations thereof and a solid electrolyte including particles having a D₅₀ size in a range from 4 μm to 12 μm. Adding binder and a conductive additive to the cathode active material and the solid electrolyte. Coating a substrate with the cathode active material, the solid electrolyte, the binder, and the conductive additive.

In other features, the cathode active material is selected from a group consisting of rock salt layered oxides, spinel, polyanion cathode, olivine cathode, other lithium transition-metal oxides, and surface-coated and/or doped cathode materials. The solid electrolyte is selected from a group consisting of pseudobinary sulfide, pseudoternary sulfide, pseudoquaternary sulfide, a halide-based solid electrolyte, and a hydride-based solid electrolyte.

In other features, the conductive additive is selected from a group consisting of carbon black, graphite, graphene, graphene oxide, Super P, acetylene black, carbon nanofibers, and carbon nanotubes. The binder is selected from a group consisting of polytetrafluoroethylene (PTFE), fluorinated ethylene propylene (FEP) fibrils, perfluoroalkoxy alkane (PFA) fibrils, and/or ethylene tetrafluoroethylene (ETFE) fibrils.

In other features, the cathode active material comprises lithium-nickel-cobalt-manganese (NMC) particles having a diameter of 2 μm<D₅₀<5 μm and the outer layer comprises LiNbO₃ having a thickness in a range from 7 nm to 13 nm. Nickel comprises 50 to 72 mol % of the NMC particles, Mn comprises 8 to 40 mol % of the NMC particles, and Co comprises 10 to 20 mol % of the NMC particles.

A wet method for manufacturing a cathode electrode for a solid-state battery cell, includes creating a mixture including a cathode active material comprising particles having an outer layer selected from a group consisting of LiNbO₃, Li₂ZrO₃, Li₃PO₄, and combinations thereof, a solid electrolyte including particles having a D₅₀ size in a range from 4 μm to 12 μm, a binder, a conductive additive, and solvent. The method includes coating the mixture onto a substrate.

In other features, the cathode active material is selected from a group consisting of rock salt layered oxides, spinel, polyanion cathode, olivine cathode, other lithium transition-metal oxides, and surface-coated and/or doped cathode materials. The solid electrolyte is selected from a group consisting of pseudobinary sulfide, pseudoternary sulfide, pseudoquaternary sulfide, a halide-based solid electrolyte, and a hydride-based solid electrolyte.

In other features, the conductive additive selected from a group consisting of carbon black, graphite, graphene, graphene oxide, Super P, acetylene black, carbon nanofibers, and carbon nanotubes. The binder is selected from a group consisting of sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS).

In other features, the cathode active material comprises lithium-nickel-cobalt-manganese (NMC) particles having a diameter of 2 μm<D₅₀<5 μm and the outer layer comprises LiNbO₃ having a thickness in a range from 7 nm to 13 nm. Nickel comprises 50 to 72 mol % of the NMC particles, manganese comprises 8 to 40 mol % of the NMC particles, and cobalt comprises 10 to 20 mol % of the NMC particles.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a solid-state battery cell including cathode electrodes, anode electrodes, and separators arranged in a battery cell enclosure according to the present disclosure;

FIG. 2 is a more detailed side cross sectional view of an example of the solid-state battery cell including cathode electrodes, anode electrodes, and separators according to the present disclosure;

FIG. 3 is a side cross sectional view of particles of the cathode active material with an outer layer made of lithium niobate (LiNbO₃), lithium zirconate (Li₂ZrO₃), and/or lithium phosphate (Li₃PO₄) according to the present disclosure;

FIG. 4A is a graph illustrating voltage as a function of capacity for varied sizes of solid electrolyte;

FIG. 4B is a graph illustrating impedance for varied sizes of solid electrolyte;

FIG. 4C is a graph illustrating capacity as a function of cycles for varied sizes of solid electrolyte;

FIG. 5 is a flowchart illustrating an example of dry processing of the cathode electrodes according to the present disclosure;

FIG. 6 is a flowchart illustrating an example of wet processing of the cathode electrodes according to the present disclosure;

FIG. 7 are enlarged views of the solid electrolyte and the electrodes for varied sizes of solid electrolyte according to the present disclosure; and

FIG. 8 are enlarged views illustrating dispersion of the solid electrolyte in the cathode electrodes for varied sizes of solid electrolyte according to the present disclosure.

In the drawings, reference numbers may be reused to identify similar and/or identical elements.

### DETAILED DESCRIPTION

While high power cathodes for solid-state battery (SSB) cells according to the present disclosure are shown in the context of electric vehicles, the high power cathodes for solid-state battery cells can be used in stationary applications and/or other applications.

Sulfide electrolyte can deliver ionic conductivity that is comparable with carbonate-based electrolyte. However, the power of a composite cathode electrode using sulfide electrolyte is hindered by sluggish ion transport in the active material/solid electrolyte interface and unfavorable ion conduction caused by poor solid electrolyte percolation within the electrode.

A high power cathode electrode for an all-solid-state battery (ASSB) according to the present disclosure includes single crystal cathode particles that include an outer layer including lithium niobate (LiNbO₃), lithium zirconate (Li₂ZrO₃), and/or lithium phosphate (Li₃PO₄) to inhibit interfacial side reactions. The cathode particles are used with solid electrolyte having a predetermined size to enable an efficient ion transport pathway within the cathode electrode. When the solid electrolyte particles in the cathode are too small, high solid electrolyte percolation occurs and lower ion transport occurs. Larger solid electrolyte particles have higher porosity and poor solid electrolyte percolation. Likewise, the thickness of the coating on the cathode particles is tailored to prevent chemical reactions (that occur without the coating) while optimizing lithium-ion transport.

For example, the cathode electrode can include lithium nickel manganese cobalt (NMC) particles that are coated with a lithium niobate (LiNbO₃) coating (e.g., with a thickness of 10 μm) to inhibit interfacial side reactions. For example, the size of the sulfide solid electrolyte particles (e.g., D₅₀=8 μm) is selected to enable an efficient ion transport pathway within the cathode electrode. For example, the high-power composite cathode electrode can deliver a 3C discharge capacity of 88 mAh/g and a 5C discharge capacity of 74 mAh/g at 25° C.

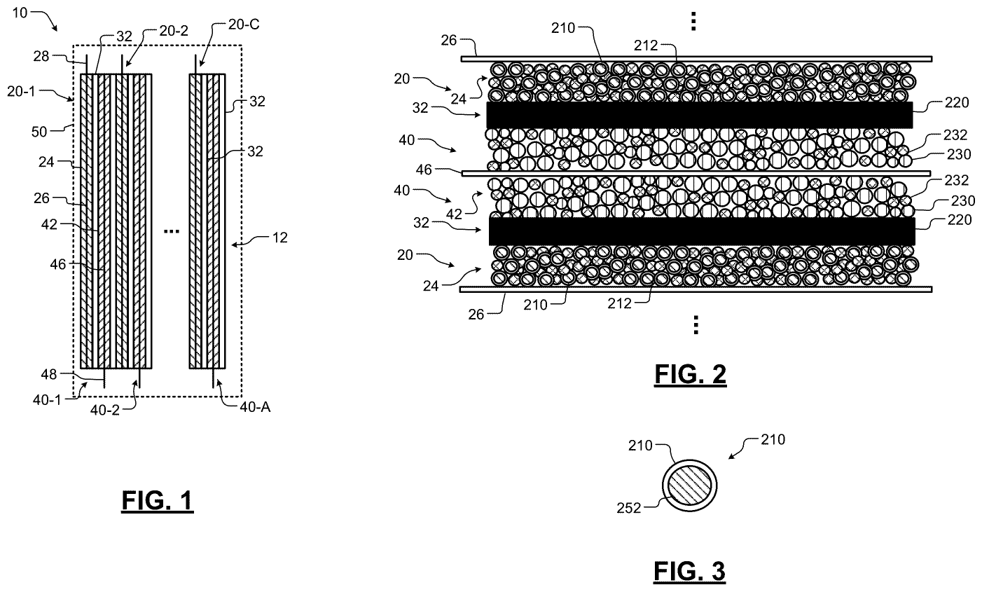

Referring now to FIG. 1, a solid-state battery cell 10 includes C cathode electrodes 20, A anode electrodes 40, and S separators 32 arranged in a predetermined sequence in a stack 12 located in an enclosure 50, where C, S and A are integers greater than zero. The C cathode electrodes 20-1, 20-2, . . . , and 20-C include cathode active layers 24 arranged on one or both sides of cathode current collectors 26. The A anode electrodes 40-1, 40-2, . . . , and 40-A include anode active layers 42 arranged on one or both sides of the anode current collectors 46.

In some examples, the anode active layers 42 and/or the cathode active layers 24 are free-standing electrodes that are arranged adjacent to (or attached to) the current collectors. In some examples, the anode active layers 42 and/or the cathode active layers 24 comprise coatings including one or more active materials, one or more conductive fillers/additives, and/or one or more binder materials that are applied to the current collectors. In some examples, the cathode current collectors 26 and/or the anode current collectors 46 comprise wire mesh, foil, and/or expanded metal. In some examples, the current collectors are made of one or more materials selected from a group consisting of copper, stainless steel, brass, bronze, zinc, aluminum, and/or alloys thereof. External tabs 28 and 48 can be connected to the current collectors of the cathode electrodes and anode electrodes on the same or opposite sides of the battery stack.

Referring now to FIGS. 2 and 3, a more detailed example of the solid-state battery cell is shown. In FIG. 2, the cathode active material layer 24 comprises cathode active material 210 and solid electrolyte 212 (e.g., sulfide solid electrolyte). The separator 32 includes solid electrolyte 220 (e.g., sulfide solid electrolyte). The anode active material layer 40 comprises anode active material 230 and solid electrolyte 232 (e.g., sulfide solid electrolyte).

In FIG. 3, the cathode active material 210 includes single crystal particles 250 of the cathode active material and an outer layer 252 coated or otherwise applied on a radially outer surface of the particles 250. In some examples, the particles 250 comprise NMC or another cathode active material described below. In some examples, the outer layer 252 comprises lithium niobate (LiNbO₃), lithium zirconate (Li₂ZrO₃), and/or lithium phosphate (Li₃PO₄), although other materials can be used. In some examples, the NMC particles 250 comprise 68 wt % to 92 wt % and the outer layer comprises 8 wt % to 32 wt %. In some examples, the weight ratio of the particles 250 to the outer layer 252 is 70:30. In some examples, the coated NMC particles inhibit interfacial side reactions and the solid electrolyte enables efficient ion transport pathways in the cathode electrode.

In some examples, the particles 250 have diameter of 2 μm<D₅₀<5 μm (e.g., 3.8 μm). In some examples, a Brunauer, Emmett and Teller (BET) surface area is in a range from 0.2 to 0.8 m²/g. In some examples, nickel (Ni) comprises 50 to 72 mol % of the NMC particles, manganese (Mn) comprises 8 to 40 mol %, and cobalt (Co) comprises 10 to 20 mol %. In some examples, the outer layer 252 has a thickness in a range from 7 nm to 13 nm (e.g., 10 nm). In some examples, the sulfide electrolyte 212 has a diameter of 4 μm<D₅₀<12 μm (e.g., 8 μm) and D₉₀<15 μm (e.g., 14.7 μm). In some examples, the sulfide electrolyte 212 has a diameter of 5 μm<D₅₀<10 μm. Ion conductivity is greater than 1 mS/cm.

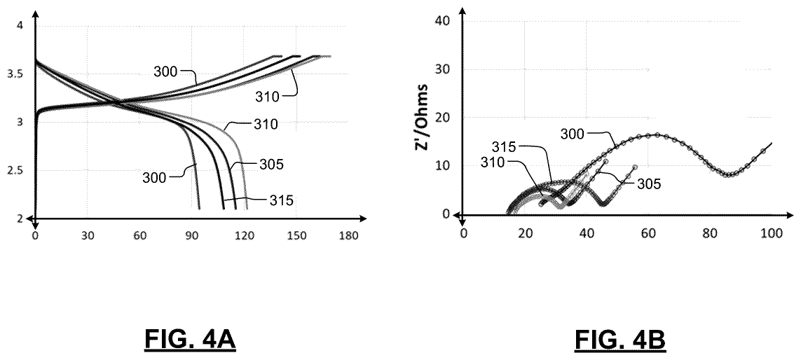

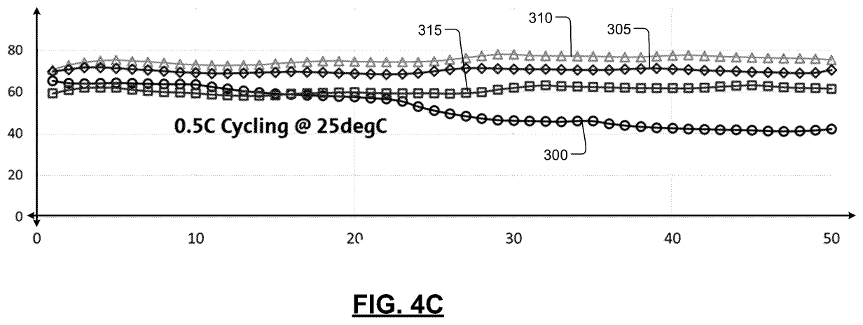

Referring now to FIGS. 4A to 4C, performance of the NMC particles with outer layers having varying thicknesses are shown. In FIG. 4A, voltage is shown as a function of capacity (mAh/g) for NMC without the outer layer (at 300), NMC with a 5 nm outer layer (at 305), NMC with a 10 nm outer layer (at 310), and NMC with a 15 nm outer layer (at 315). Some of the coated NMC examples (e.g., 5 nm and 10 nm coatings) outperform the uncoated NMC. In FIG. 4B, impedance of the coated and uncoated NMC is shown. Some of the coated NMC examples (e.g., 5 nm and 10 nm coatings) have lower resistance.

In FIG. 4C, capacity is shown as a function of cycles. Some of the coated NMC examples (e.g., 5 nm and 10 nm coatings) have higher capacity as compared to the uncoated NMC. As can be appreciated, an electrochemical/chemical stable NMC/SE interface is enabled by the LiNbO₃ coating. NMC with the 10 nm coating shows the lowest interface resistance with sulfide electrolyte.

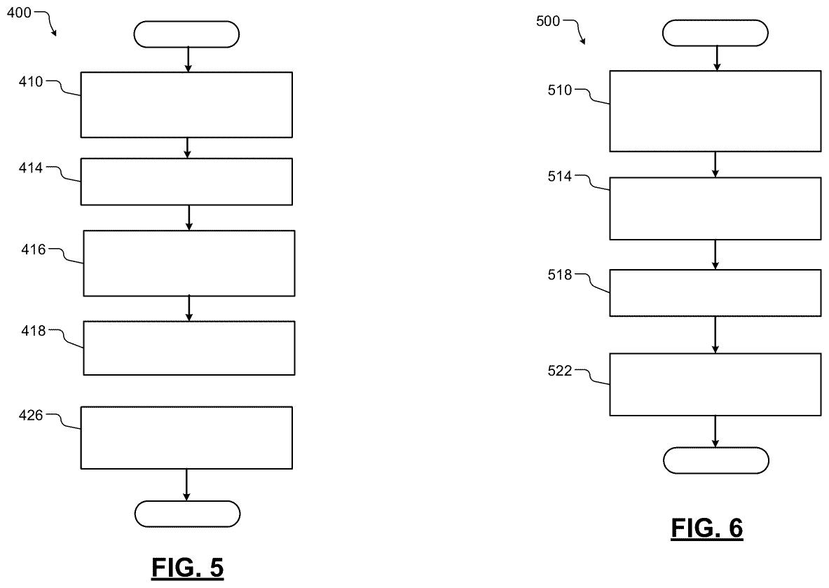

Referring now to FIG. 5, a method 400 for manufacturing a cathode electrode using a dry process is shown. At 410, coated cathode active material and solid sulfide electrolyte particles are mixed. At 414, binder and conductive additive are added to the coated cathode active material and solid sulfide electrolyte and mixed. At 416, the mixture is sheared (e.g., to fibrillate the binder) and pressed and/or roll to form a free-standing cathode membrane. At 418, the membrane is attached to a cathode current collector. In some examples, one or more sets of rollers can be used to apply pressure and/or heat (or another device can be used). At 426, anode electrodes, the cathode electrodes, and separators are arranged in a battery cell.

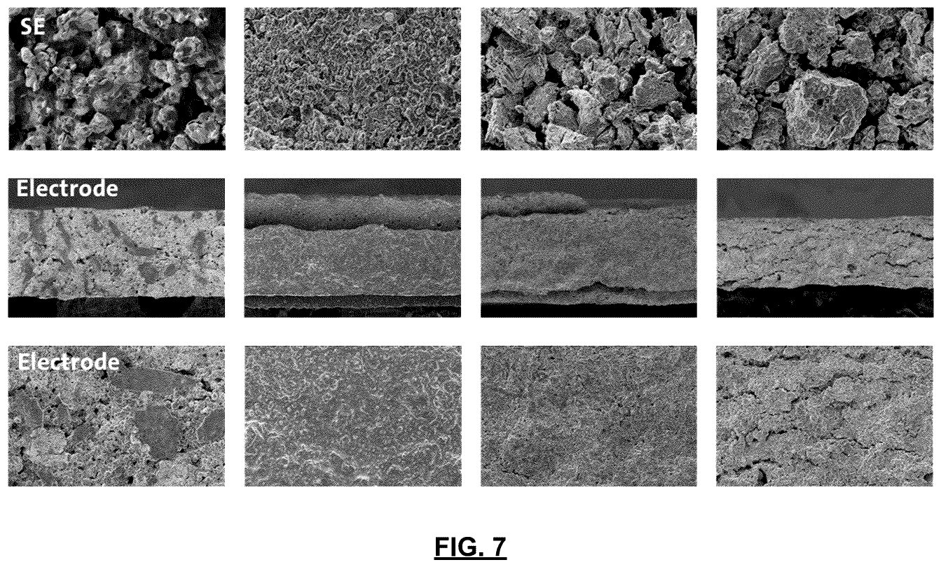

Referring now to FIG. 6, a method 500 for manufacturing a cathode electrode is shown. At 510, coated cathode active material, solid sulfide electrolyte, solvent, binder, and conductive additive are mixed. At 514, the mixture is coated onto a cathode current collector. At 518, the mixture is pressed and/or heated with a roller or other device to form the cathode electrode. At 522, the anode electrodes, the cathode electrodes, and the separators are arranged in a battery cell.

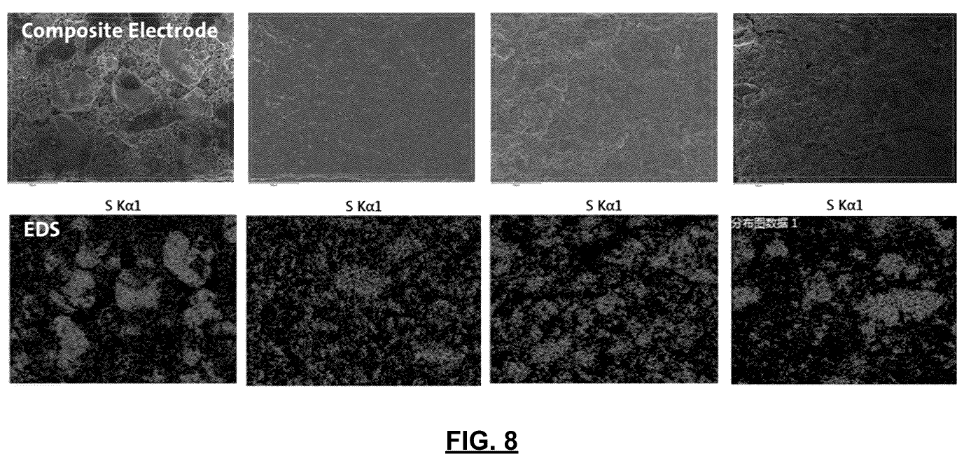

Referring now to FIGS. 7 and 8, the influence of the size of the sulfide solid electrolyte is shown. In FIG. 7, enlarged views of the solid electrolyte and the cathode electrode are shown. When 5 μm and 8 μm are used, the closest packing of the cathode electrode occurs after pressing. Random sizes and larger sizes (e.g., 15 μm) have voids after pressing. In FIG. 8, distribution of the sulfide solid electrolyte is more uniform for 5 μm and 8 μm as compared to random or larger sizes (e.g., 15 μm).

In some examples, the solid electrolyte includes sulfide solid electrolyte selected from a group consisting of pseudobinary sulfide, pseudoternary sulfide, and pseudoquaternary sulfide. Examples of pseudobinary sulfide include Li₂S—P₂S₅ system (Li₃PS₄, Li₇P₃S₁₁ and Li_{9.6}P₃S₁₂), Li₂S—SnS₂ system (Li₄SnS₄), Li₂S—SiS₂ system, Li₂S—GeS₂ system, Li₂S—B₂S₃ system, Li₂S—Ga₂S₃ system, Li₂S—P₂S₃ system, Li₂S—Al₂S₃ system, and combinations thereof.

Examples of pseudoternary sulfide include Li₂O—Li₂S—P₂S₅ system, Li₂S—P₂S₅—P₂O₅ system, Li₂S—P₂S₅—GeS₂ (e.g., Li_{3.25}Ge_{0.25}P_{0.75}S₄ and Li₁₀GeP₂S₁₂), Li₂S—P₂S₅—LiX (X=F, Cl, Br, I) system (Li₆PS₅Br, Li₆PS₅Cl, L₇P₂S₈I and Li₄PS₄I), Li₂S—As₂S₅—SnS₂ system (Li_{3.833}Sn_{0.833}As_{0.166}S₄), Li₂S—P₂S₅—Al₂S₃ system, Li₂S—LiX—SiS₂ (X=F, Cl, Br, I) system, 0.4LiI·0.6Li₄SnS₄, Li₁₁Si₂PS₁₂, and combinations thereof.

Examples of pseudoquaternary sulfide include Li₂O—Li₂S—P₂S₅—P₂O₅ system, Li_{9.54}Si_{1.74}P_{1.44}S_{1.7}Cl_{0.3}, Li₂P_{2.9}Mn_{0.1}S_{10.7}I_{0.3}, Li_{10.35} [Sn_{0.27}Si_{1.08}]P_{1.65}S₁₂, and combinations thereof.

In other examples, the solid electrolyte includes halide-based solid electrolyte, hydride-based solid electrolyte, or other solid electrolyte that possesses low grain-boundary resistance. Examples of halide-based solid electrolyte. e.g., Li₃YCl₆, Li₃InCl₆, Li₃YBr₆, LiI, Li₂CdCl₄, Li₂MgCl₄, Li₂Cd₁₄, Li₂Zn₁₄, and Li₃OCl. Examples of hydride-based solid electrolyte include LiBH₄, LiBH₄—LiX (X=chlorine (Cl), bromine (Br), or iodine (I)), LiNH₂, Li₂NH, LiBH₄—LiNH₂, Li₃AlH₆, and combinations thereof.

In some examples, the cathode active material is selected from a group consisting of rock salt layered oxides, spinel, polyanion cathode, olivine cathode, other lithium transition-metal oxides, surface-coated and/or doped cathode materials, and low voltage cathode materials.

In some examples, the anode active material is selected from a group consisting of carbonaceous material (e.g., graphite, hard carbon, soft carbon, etc.), silicon, silicon mixed with graphite, Li₄Ti₅O₁₂, transition-metals (e.g., tin (Sn)), metal oxide/sulfide (e.g., titanium oxide (TiO₂), iron sulfide (FeS), etc.), and other lithium-accepting anode materials.

Examples of the rock salt layered oxides (LiCoO₂, LiNiₓMn_{y}Co_{1-x-y}O₂, LiNiₓMn_{y}Al_{1-x-y}O₂, LiNiₓMn₁₋ₓO₂, Li₁₊ₓMO₂). Examples of spinel include LiMn₂O₄, LiNi_{0.5}Mn_{1.5}O₄. Examples of polyanion cathode include LiV₂(PO₄)₃). Examples of olivine include LiFePO₄ and LiMnₓFe₁₋ₓPO₄.

Examples of surface-coated and/or doped cathode materials are mentioned above and further include LiNbO₃-coated LiMn₂O₄, Li₂ZrO₃ or Li₃PO₄-coated LiNiₓMn_{y}Co_{1-x-y}O₂, and Al-doped LiMn₂O₄. Examples of low voltage cathode material include lithiated metal oxide/sulfide (e.g., LiTiS₂), lithium sulfide, and sulfur.

In some examples, the conductive additive is selected from a group consisting of carbon black, graphite, graphene, graphene oxide, Super P, acetylene black, carbon nanofibers, carbon nanotubes, and other electronically conductive additives.

In some examples, the binder is selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (N BR), styrene ethylene butylene styrene copolymer (SEBS), and styrene butadiene styrene copolymer (SBS).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A solid-state battery cell comprising:
A anode electrodes including an anode active material layer arranged on an anode current collector;
C cathode electrodes including a cathode active material layer arranged on a cathode current collector, wherein the cathode active material layer includes:
cathode active material comprising particles including an outer layer of a material selected from a group consisting of LiNbO₃, Li₂ZrO₃, Li₃PO₄, and combinations thereof; and
a solid electrolyte having a D₅₀ size in a range from 4 μm to 12 μm; and
S separators arranged between the A anode electrodes and the C cathode electrodes, where A, C, and S are integers greater than one.

2. The solid-state battery cell of claim 1, wherein the particles comprise lithium-nickel-cobalt-manganese (NMC) particles and the outer layer comprises LiNbO₃.

3. The solid-state battery cell of claim 2, wherein the NMC particles have diameter of 2 μm<D₅₀<5 μm.

4. The solid-state battery cell of claim 2, wherein nickel comprises 50 to 72 mol % of the NMC particles, manganese comprises 8 to 40 mol % of the NMC particles, and cobalt comprises 10 to 20 mol % of the NMC particles.

5. The solid-state battery cell of claim 1, wherein the outer layer has a thickness in a range from 7 nm to 13 nm.

6. The solid-state battery cell of claim 1, wherein the solid electrolyte in the cathode active material layer has a diameter D₉₀<15 μm.

7. The solid-state battery cell of claim 1, wherein the solid electrolyte comprises a sulfide solid electrolyte selected from a group consisting of pseudobinary sulfide, pseudoternary sulfide, and pseudoquaternary sulfide.

8. The solid-state battery cell of claim 1, wherein the solid electrolyte is selected from a group consisting of halide-based solid electrolyte and hydride-based solid electrolyte.

9. The solid-state battery cell of claim 1, wherein the cathode active material is selected from a group consisting of rock salt layered oxides, spinel, polyanion cathode, olivine cathode, other lithium transition-metal oxides, surface-coated and/or doped cathode materials, and combinations thereof.

10. The solid-state battery cell of claim 1, wherein the cathode active material layer further comprises conductive additive selected from a group consisting of carbon black, graphite, graphene, graphene oxide, Super P, acetylene black, carbon nanofibers, carbon nanotubes, and combinations thereof.

11. The solid-state battery cell of claim 1, wherein the cathode active material layer further comprises a binder selected from a group consisting of polytetrafluoroethylene (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), and combinations thereof.

12. A dry method for manufacturing a cathode electrode for a solid-state battery cell, comprising:
mixing cathode active material comprising particles having an outer layer selected from a group consisting of LiNbO₃, Li₂ZrO₃, Li₃PO₄, and combinations thereof and a solid electrolyte including particles having a D₅₀ size in a range from 4 μm to 12 μm; and
adding binder and a conductive additive to the cathode active material and the solid electrolyte; and
coating a substrate with the cathode active material, the solid electrolyte, the binder, and the conductive additive.

13. The dry method for manufacturing of claim 12, wherein:
the cathode active material is selected from a group consisting of rock salt layered oxides, spinel, polyanion cathode, olivine cathode, other lithium transition-metal oxides, and surface-coated and/or doped cathode materials, and
the solid electrolyte is selected from a group consisting of pseudobinary sulfide, pseudoternary sulfide, pseudoquaternary sulfide, a halide-based solid electrolyte, and a hydride-based solid electrolyte.

14. The dry method for manufacturing of claim 12, wherein:
the conductive additive is selected from a group consisting of carbon black, graphite, graphene, graphene oxide, Super P, acetylene black, carbon nanofibers, and carbon nanotubes, and
the binder is selected from a group consisting of polytetrafluoroethylene (PTFE), fluorinated ethylene propylene (FEP) fibrils, perfluoroalkoxy alkane (PFA) fibrils, and/or ethylene tetrafluoroethylene (ETFE) fibrils.

15. The dry method for manufacturing of claim 12, wherein:
the cathode active material comprises lithium-nickel-cobalt-manganese (NMC) particles having a diameter of 2 μm<D₅₀<5 μm and the outer layer comprises LiNbO₃ having a thickness in a range from 7 nm to 13 nm, and
nickel comprises 50 to 72 mol % of the NMC particles, Mn comprises 8 to 40 mol % of the NMC particles, and Co comprises 10 to 20 mol % of the NMC particles.

16. A wet method for manufacturing a cathode electrode for a solid-state battery cell, comprising:
creating a mixture including:
a cathode active material comprising particles having an outer layer selected from a group consisting of LiNbO₃, Li₂ZrO₃, Li₃PO₄, and combinations thereof,
a solid electrolyte including particles having a D₅₀ size in a range from 4 μm to 12 μm,
a binder,
a conductive additive, and
solvent; and
coating the mixture onto a substrate.

17. The wet method for manufacturing of claim 16, wherein:
the cathode active material is selected from a group consisting of rock salt layered oxides, spinel, polyanion cathode, olivine cathode, other lithium transition-metal oxides, and surface-coated and/or doped cathode materials, and
the solid electrolyte is selected from a group consisting of pseudobinary sulfide, pseudoternary sulfide, pseudoquaternary sulfide, a halide-based solid electrolyte, and a hydride-based solid electrolyte.

18. The wet method for manufacturing of claim 16, wherein:
the conductive additive selected from a group consisting of carbon black, graphite, graphene, graphene oxide, Super P, acetylene black, carbon nanofibers, and carbon nanotubes, and
the binder is selected from a group consisting of sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), and styrene butadiene styrene copolymer (SBS).

19. The wet method for manufacturing of claim 16, wherein:
the cathode active material comprises lithium-nickel-cobalt-manganese (NMC) particles having a diameter of 2 μm<D₅₀<5 μm and the outer layer comprises LiNbO₃ having a thickness in a range from 7 nm to 13 nm, and
nickel comprises 50 to 72 mol % of the NMC particles, manganese comprises 8 to 40 mol % of the NMC particles, and cobalt comprises 10 to 20 mol % of the NMC particles.
